(19) United States
(12) Patent Application Publication
(10) Pub. No.: US 2026/0118656 A1
(43) Pub. Date: Apr. 30, 2026

(54) Freeform Surface Variable Focusing Lens with ASIC Control Integrated Micromirror Array Device

(71) Applicant: SD OPTICS, INC., SEOUL (KR)

(72) Inventors: JIN YOUNG SOHN, SEOUL (KR); MIN BEOM LEE, SEOUL (KR); HONG JU KIM, SEOUL (KR); KYUNG PYO HONG, SEOUL (KR); GYOUNG IL CHO, Seoul (KR); CHEONG SOO SEO, Seoul (KR)

(21) Appl. No.: 18/932,360

(22) Filed: Oct. 30, 2024

(51) Int. Cl. G02B 26/08

(52) U.S. Cl. CPC G02B 26/0841

(57) ABSTRACT

The present invention introduces A freeform variable focusing lens with ASIC control integrated micromirror array. The freeform variable focusing lens with ASIC control integrated micromirror array can generate multiple optical surface profiles with freeform surfaces wherein the freeform surface is controlled by a plurality of the ASIC electrodes. The plurality of the ASIC electrodes goes to the plurality of the MEMS electrodes through the connecting means. The ASIC device and the micromirror mirror array device in the freeform variable focusing lens with ASIC control integrated micromirror array device are separately fabricated in wafer-level. The separately fabricated ASIC device and micromirror array device are wafer-bonded for the final freeform variable focusing lens device. Thanks to the integration of the ASIC control with the micromirror array device, multiple freeform surfaces can be generated with individual tenability of the micromirrors with multiple degrees of freedom. With large number of motion freedom, the freeform variable focusing lens device generate variable focusing lens with time control.

### FIELD OF THE INVENTION

The present invention relates to a freeform surface variable focusing lens with ASIC (Application-Specific Integrated Circuit) control integrated micromirror array device and controlling the variable focusing lens with integrated ASIC control with freeform optical surface profiles and making the same.

### BACKGROUND OF THE INVENTION

To control light, micromirror array device is widely used especially after DMD (digital micromirror device) is in market. Micromirror array devices are mostly used for MEMS (Micro-Electro-Mechanical System) technology to have control over small mechanical moving parts. Devices with MEMS technology incorporating both electronic and moving parts are extremely small, ranging in size from micrometers to hundreds of micrometers. In addition, MEMS devices utilize electrostatic forces, surface tension, and mechanical forces. Electrostatic forces use capacitive forces between charges to attract each other, so it has the advantage of very low power consumption and fast operation speed. Also frequently, MEMS devices are built with semiconductor fabrication processes. This enables mass production of extremely small form of products at a low cost. MEMS devices are utilized as actuators and sensors in various fields including automotive airbag sensors, smartphone accelerometer sensors, and biochips for decoding genetic information.

Most micromirror devices with MEMS technology have a direct control from outside circuit controller. FIG. 1 shows the brief diagram of the micromirror array device. Most control signal from the PCBs (Printed Circuit Board) 101 where the MEMS micromirror array device 103 is bonded and receive most of control signals for the MEMS micromirror array device. The signal is directly connected through the wire-bonding 102 from the MEMS micromirror array device 103 surface to the electrodes in the PCBs 101. Some special wire-bonding connection like ground 105 are also provided for special cases. The micromirrors in the effective area 104 are controlled through directly wire-bonding wires. But the limitation of wire-bonding density, yields of fabricating the device and the area of the MEMS device makes the number of channels for the micromirror array device strictly limited with the number of the wire-bonding pads.

To overcome this channel limitation, while making DMD devices, CMOS (Complementary Metal-Oxide-Semiconductor) is used to switch the micromirrors and to control the micromirrors at the same time. To accommodate the CMOS technology with micromirror array device, Texas Instruments and Fraunhofer have adopted a method for producing a micromirror array device by directly stacking MEMS structures on top of a CMOS wafer, as shown in FIG. 2A in U.S. Pat. No. 9,950,924 B2 issued Apr. 24, 2018 to Sridharamurthy, U.S. Pat. No. 8,541,850 B2 issued Sep. 24, 2013 to Gupta, and U.S. Pat. No. 9,546,090 B1 issued Jan. 17, 2017 to Xia. Since MEMS structures are deposited directly on the CMOS circuit wafer, there is no need for wire bonding, enabling a rapid electrical transmission speed could be achieved.

DMD (Digital Micromirror Device) developed by Texas Instruments is one of the micromirror devices consisting of millions of mirrors capable of rotating between 12 to 17 degrees from its non-operating position, as shown in FIG. 2B in U.S. Pat. No. 5,583,688 issued Dec. 10, 1996 in Hornbeck. DMD mirrors change the amount of optical light, which controls the light of the corresponding pixel and using PWM (Pulse Width Modulation) technique, thus it can control the brightness of the pixels. DLP (Digital Light Processing) projectors with DMDs are used in a variety of applications, including large theaters, automotive heads-up displays, and augmented reality in U.S. Pat. No. 10,527,726 B2 issued Jan. 7, 2020 to Bartlett. However, the motion of DMD is limited to binary states of on and off, making it incapable of controlling the amount of rotation. It can only be digitally controlled with an On/Off mechanism. Therefore, it cannot be used for applications where the angular amount of individual micromirrors should be controlled, such as adaptive optics for wavefront correction, due to the limitations of technology and the requirements for the more complicated spatial light modulating devices.

Another method of stacking MEMS dies are disclosed in U.S. Pat. No. 11,708,264B2 issued Jul. 25, 2023 to Gupta. In this patent, multiple MEMS dies are stacked on top of one MEMS. With this configuration, multi-functional MEMS devices can be built and more degrees of freedom control can be achieved compared with cases in FIG. 1.

With this configuration, some devices can be operated at a lower stage, and some can be operated at a higher stage. Especially for the light modulating devices, stacking MEMS device would generate more problems of light scattering with very little increment of the control channels.

From the DMD cases, more controlling is studied and disclosed in the U.S. Pat. No. 7,304,782 B2 issued Dec. 4, 2007 to Kimura. Drive circuits are built under the micromirror array electrodes and the micromirror array device is digitally controlled by the drive circuits. The schematics of the disclosure is illustrated in FIG. 4. Drive circuits are working more systematic ways, but still, the operation is limited with digital control of the micromirrors or the control only for tri-stable stage motion of the micromirrors in the micromirror array device. This can be used only for limited motion generation of the micromirrors with limited tenability. Building driving circuitry before fabricating MEMS structures, especially when silicon MEMS processes are used, is extremely difficult due to the temperature of the silicon MEMS processes.

To overcome the above mentioned difficulties, the present invention introduces a method of building the MEMS micromirror array device and the ASIC control device separately. Making MEMS micromirror array device and the ASIC control device separately gives freedom of choice for the fabrication processes. For MEMS fabrication, MEMS process can be used. Separately, for ASIC fabrication, semiconductor full processes can be used. With the present invention, the limitation of the control channels can be overcome and even more than tens of thousands of control channels can be built. For details, see the detailed description of the invention.

With the present invention of the freeform surface variable focusing lens with ASIC control integration, independent control of the individual micromirrors in the micromirror array, easier access to the micromirror control and compact packaging for the micromirror array device with control circuitry can be accomplished. Examples and its applications of the individually controllable micromirror array are described in the U.S. patent application Ser. No. 18/384,721 filed Oct. 27, 2023, which is incorporated herein by references.

The freeform surface variable focusing lens device is a good example for the application of the ASIC integrated MEMS device with a plurality of control channels. By the advantages of the ASIC integrated MEMS micromirror array device, usage of the micromirror array device can be extended enormously. More applications and MEMS structures with examples and the general principle, structure and methods for making the micromirror array devices and Micromirror Array Lens are disclosed in U.S. Pat. No. 7,330,297 issued Feb. 12, 2008 to Noh, U.S. Pat. No. 7,365,899 issued Apr. 29, 2008 to Gim, U.S. Pat. No. 7,382,516 issued Jun. 3, 2008 to Sco, U.S. Pat. No. 7,400,437 issued Jul. 15, 2008 to Cho, U.S. Pat. No. 7,411,718 issued Aug. 12, 2008 to Cho, U.S. Pat. No. 7,474,454 issued Jan. 6, 2009 to Sco, U.S. Pat. No. 7,777,959 issued Aug. 17, 2010 to Sohn, U.S. Pat. No. 7,488,082 issued Feb. 10, 2009 to Kim, U.S. Pat. No. 7,535,618 issued May 19, 2009 to Kim, U.S. Pat. No. 7,898,144 B2 issued Mar. 1, 2011 to Seo, U.S. Pat. No. 7,777,959 B2 issued Aug. 17, 2010 to Sohn, U.S. Pat. No. 7,589,884 B2 issued Sep. 15, 2009 to Sohn, U.S. Pat. No. 7,589,885 B2 issued Sep. 15, 2009 to Sohn, U.S. Pat. No. 7,605,964 B2 issued Oct. 20, 2009 to Gim, and U.S. Pat. No. 9,505,606 B2 issued Nov. 29, 2016 to Sohn, all of which are incorporated herein by references.

### SUMMARY OF THE INVENTION

The present invention of the freeform variable focusing lens with ASIC (Application-Specific Integrated Circuit) integrated micromirror array implements micromirror array device for forming optical surface profiles with variable focusing properties and ASIC control device to control the micromirror array device directly through many TSVs (Through Silicon Via) directly from the ASIC device to the micromirror array device. The ASIC control device and the micromirror array device are fabricated with wafer bonding technology and built together in wafer level and diced later for a final device.

The micromirror array device generates many optical surfaces profiles with various optical system configurations. To achieve this goal and form optical surface profiles, each micromirror in the micromirror array device should have multiple degrees of freedom motion. Preferably three degrees of motion with two rotational degrees of freedom for tip and tilt motion, and one translational degree of freedom for piston motion. With these three degrees of freedom of motion, each micromirror in the micromirror array device can represent a small area (micro-size portion of the optical effective area or clear aperture) of the optical surface profile. Also each micromirror in the micromirror array device should have individual and independent control for its motion including two degrees of rotation and one degree of translation since every portion of the optical surface profile represent different motion for the pre-determined optical surface profiles. Only under some specific symmetry conditions, the motion can have lesser degrees of freedom and simpler control method. But for general optical surface profiles with various geometries, individual and independent control of each micromirror is necessary for forming optical surface profiles.

This individual and independent control of said each micromirror requires lots of control signals (voltages) to the micromirror array device. If we assume that there are N micromirrors in the micromirror array device and each mirror have M degrees of freedom motion (usually 3), then we need at least N×M channels of control signals whether they are controlled sequentially or in parallel. Also these many control channels are difficult to implement in the small form factor MEMS device.

To overcome this problem, the present invention introduces an ASIC control integrated micromirror array device which can form freeform optical surface profiles for variable focusing lens device. The ASIC control integrated micromirror array comprises basically two big parts. One is ASIC control device and the other is the micromirror array device. The ASIC control device generates multiple control channels (N×M channels for controlling each micromirror with M degrees of freedom motion) and intermediately deliver those control signals to the plurality of ASIC electrode. The plurality of ASIC electrodes are connected to the plurality of the MEMS electrodes in the micromirror array device through the connecting means (TSVs in the substrate of the micromirror array device). These MEMS electrodes independently operate the actuators in the micromirrors. Since each electrode is independently controlled, each micromirror can have different motion (tip, tilt, piston) with multiple degrees of freedom motion individually and independently. Preferably, each micromirror has M numbers of actuators, thus M numbers of the MEMS electrodes. How to control the micromirror for the desired motion with multiple degrees of freedom is described in many prior art patents and papers. Here are some examples of the multiple degrees of freedom micromirror motion control systems and their structures.

As shown in FIG. 1 (prior art), most simple connection for controlling multiple degrees of freedom micromirror motion control is direct connection for the control pads from the MEMS substrate to the control PCB connection. Here the number of control channels is directly limited by the number of the connection pads on the MEMS substrate thus the area of the MEMS device.

FIG. 3 shows the multi-stack MEMS device with multi-layered MEMS device stacks, wire-bonding is distributed to the multiple stacks of the MEMS device. This idea is disclosed in U.S. Pat. No. 11,708,264 B2 issued Jul. 25, 2023 to Gupta. In this configuration, more wire bonding connections can be achieved but still the total number of the connections is limited with the sum of the MEMS pad areas. Also the effective area (exposed area of the MEMS device) is limited, which is critical for the light receiving devices like micromirror array devices.

As also seen in FIG. 2 and FIG. 4, CMOS array is fabricated before the MEMS device is built. This array can have more complicated control for the micromirror array devices but still mostly constraints with digital processing with on/off device. Also since the CMOS fabricating process is performed at lower temperature than that of the silicon MEMS processes, fully utilizing the silicon MEMS processes is difficult or sometime impossible due to temperature restriction.

To overcome difficulties mentioned above, the present invention introduces a method of building the MEMS micromirror array device and the ASIC control device separately. Making the MEMS micromirror array device and the ASIC control device separately gives freedom of choice for the fabrication processes. Also the separate ASIC control device gives freedom of having more channels of the control voltages with control logics. And introducing the connecting means through the MEMS substrate gives more freedom for the number of the control channels. For MEMS fabrication, MEMS process can be used. And for ASIC fabrication, semiconductor full processes can be used. With the present invention, the limitation of the control channels can be overcome even more than tens of thousands of control channels. For details, see the detailed description of the invention

Also as applications of the freeform variable focusing lens with ASIC control integrated micromirror array device, the general principle and methods for making the micromirror array device and Micromirror Array Lens are disclosed in U.S. Pat. No. 6,970,284 issued Nov. 29, 2005 to Kim, U.S. Pat. No. 7,031,046 issued Apr. 18, 2006 to Kim, U.S. Pat. No. 6,934,072 issued Aug. 23, 2005 to Kim, U.S. Pat. No. 6,934,073 issued Aug. 23, 2005 to Kim, U.S. Pat. No. 7,161,729 issued Jan. 9, 2007 to Kim, U.S. Pat. No. 6,999,226 issued Feb. 14, 2006 to Kim, U.S. Pat. No. 7,095,548 issued Aug. 22, 2006 to Cho, U.S. Pat. No. 7,239,438 issued Jul. 3, 2007 to Cho, U.S. Pat. No. 7,267,447 issued Sep. 11, 2007 to Kim, U.S. Pat. No. 7,274,517 issued Sep. 25, 2007 to Cho, and U.S. Pat. No. 7,777,959 issued Aug. 17, 2010 to Sohn, U.S. Pat. No. 7,489,434 issued Feb. 10, 2009 to Cho, U.S. Pat. No. 7,619,807 issued Nov. 17, 2009 to Back, all of which are incorporated herein by references.

The general principle, structure and methods for making the micromirror array devices and Micromirror Array Lens are disclosed in U.S. Pat. No. 7,382,516 issued Jun. 3, 2008 to Sco, U.S. Pat. No. 7,330,297 issued Feb. 12, 2008 to Noh, U.S. Pat. No. 7,898,144 issued Mar. 1, 2011 to Sco, U.S. Pat. No. 7,474,454 issued Jan. 6, 2009 to Sco, U.S. Pat. No. 7,777,959 issued Aug. 17, 2010 to Sohn, U.S. Pat. No. 7,365,899 issued Apr. 29, 2008 to Gim, U.S. Pat. No. 7,589,884 issued Sep. 15, 2009 to Sohn, U.S. Pat. No. 7,589,885 issued Sep. 15, 2009 to Sohn, U.S. Pat. No. 7,400,437 issued Jul. 15, 2008 to Cho, U.S. Pat. No. 7,488,082 issued Feb. 10, 2009 to Kim, and U.S. Pat. No. 7,535,618 issued May 19, 2009 to Kim, U.S. Pat. No. 7,605,964 issued Oct. 20, 2009 to Gim, U.S. Pat. No. 7,411,718 issued Aug. 12, 2008 to Cho, U.S. Pat. No. 9,505,606 issued Nov. 29, 2016 to Sohn, U.S. Pat. No. 8,622,557 issued Jan. 7, 2014 to Cho, U.S. Pat. Pub. No. 2009/0303569 A1 published Dec. 10, 2009 to Cho, all of which are incorporated herein by references.

In summary, the freeform variable focusing lens with ASIC control integrated micromirror array device has the advantages compared with prior arts: (1) the ASIC control can generate more channels of the control voltages thus more freedom of the control to the micromirror array device. (2) the micromirror array device can have large number of degrees of freedom motion as implemented with the ASIC control channels. (3) the control of the ASIC device is performed through the exposed bond-pads from bottom attached ASIC can provide an easier electrical connection method to the MEMS device with a large number of control channels. (4) the connection means from the ASIC device electrodes to the MEMS micromirror array device electrodes can be achieved by utilizing TSV technology and wafer-bonding technology, which makes the process simple and separation of the ASIC device and the MEMS micromirror array device gives freedom for the fabrication process selection. (5) Thanks to the large number of freedom motion control possibility, the freeform variable focusing lens with ASIC control integrated micromirror array device can have freeform optical surface profiles with individual controls of the individual micromirrors in the micromirror array lens device. (6) The freeform variable focusing lens with ASIC control can generate optical surface profiles with varying optical properties of the micromirror array device, thus can change the focal length of the optical systems and varies the focal length of the optical systems and other optical properties such as aberration correction, intensity control, distortion compensation, etc.

The freeform variable focusing lens with ASIC control provides an approach for mass production through wafer level packaging method rather than individual device level, which can be a breakthrough for the highly populated multi-channel MEMS freeform variable focusing lens devices and applications.

Although the present invention is briefly summarized, the full understanding of the invention can be obtained by the following drawings, detailed descriptions, and appended claims.

### DESCRIPTION OF FIGURES

These and other features, aspects and advantages of the present invention will become better understood with reference to the accompanying drawings, wherein

FIG. 1 (prior art) illustrates general configuration of channel connections of MEMS and MEMS control logic outside of the MEMS device (prior art);

FIG. 2 (prior art) illustrates structure of Texas Instrument DMD device layer by layer (prior art);

FIG. 3 (prior art) illustrates multi-stacked MEMS device and its wire connection to outside control logics (prior art);

FIG. 4 (prior art) illustrates the drive circuit integrated MEMS device and its controlling method with digital motion (prior art);

FIG. 5 illustrates the schematics of the micromirror array device including micromirrors, actuators, substrates and TSVs with square type micromirror arrangement;

FIG. 6 illustrates the schematics of the micromirror array device including micromirrors, actuators, substrates and TSVs with hexagonal type micromirror arrangement (honeycomb structure);

FIG. 7 illustrates the ASIC device with the ASIC electrodes on top of the ASIC device and the electrodes are arranged in square shape to match with the micromirror array device;

FIG. 8 illustrates the ASIC device with the ASIC electrodes on top of the ASIC device and the electrodes are arranged in hexagonal shape to match with the micromirror array device;

FIG. 9 illustrates the ASIC device with the ASIC electrodes on top of the ASIC device and the electrodes are arranged in hexagonal honeycomb structure but with square shape electrodes;

FIG. 10 illustrates the micromirror array device and the ASIC device together arranged wherein the MEMS electrodes and the ASIC electrodes are matched with each other and arranged with square shape micromirror geometry;

FIG. 11 illustrates the micromirror array device and the ASIC device together arranged wherein the MEMS electrodes and the ASIC electrodes are matched with each other and arranged with hexagonal shape micromirror geometry;

FIG. 12 illustrates the bonded structure of the micromirror array device and the ASIC device and arranged with square shape micromirror geometry wherein the MEMS electrodes and the ASIC electrodes are aligned with each other;

FIG. 13 illustrates the optical surface profile with bonded structure of the micromirror array device and the ASIC device and arranged with hexagonal shape micromirror geometry wherein the MEMS electrodes and the ASIC electrodes are aligned with each other;

FIG. 14 illustrates the generated optical surface profile of the freeform surface variable focusing lens with ASIC control integrated micromirror array device with square type micromirrors;

FIG. 15 illustrates the generated optical surface profile of the freeform surface variable focusing lens with ASIC control integrated micromirror array device with hexagonal type micromirrors;

FIG. 16 illustrates the diagram for generating optical surface profile with micromirrors in the freeform surface variable focusing lens with ASIC control integrated micromirror array device (example is an off-axis parabolic mirror with fixed focal length and reflective angle);

FIG. 17 illustrates the optical surface profile of the variable focusing lens wherein the freeform variable focusing lens with ASIC control integrated micromirror array represent a parabolic surface shape to focus with 45 degree of incident angle to the optical surface (concave and convex);

FIG. 18 illustrates control steps of the freeform variable focusing lens with ASIC control integrated micromirror array operation, generating optical surface profiles and foci;

### DETAILED DESCRIPTION OF THE ILLUSTRATED EMBODIMENTS

The present invention of freeform variable focusing lens with ASIC control integrated micromirror array presents a new method for building micromirror array device with individually controlled multiple degrees of freedom motion micromirrors. The present invention of the freeform variable focusing lens with ASIC control integrated micromirror array comprises a micromirror array device forming reflective type freeform optical surfaces with variable focusing property wherein the micromirror array device comprises a plurality of micromirrors wherein the micromirrors are arranged in an array and said each micromirror have at least two actuators with individually and independently controlled electrodes, a substrate for the micromirror array device wherein the said substrate has a plurality of MEMS electrodes to operate the individual actuators, and a plurality of connecting means connected through the substrate from one side of the substrate (where the micromirrors are present) to the other side of the substrate to deliver control voltages of the electrodes. The present invention is also utilizing the wafer-bonding technology for mass production. The present invention of the freeform variable focusing lens with ASIC control integrated micromirror array is described in detail especially, how to build and operate the freeform variable focusing lens.

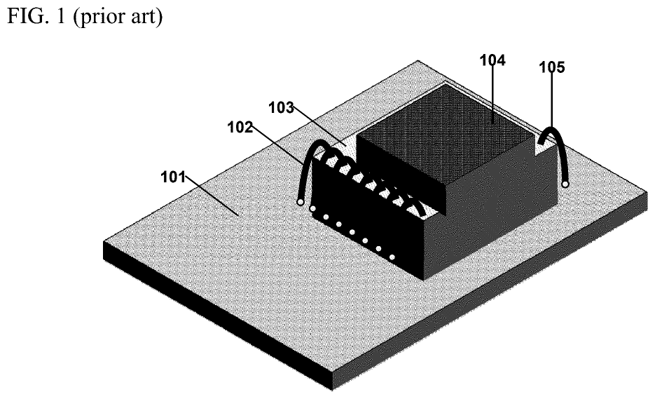

FIG. 1 (prior art) shows the typical system configuration where MEMS and control logic circuit ICs (prior art) are used together. The MEMS device (structures) 104 are fabricated on a MEMS wafer substrate 103 through MEMS and semiconductor processes. To establish a connection with the control logic circuit 101, the MEMS wafer substrate 103 is attached onto packaging PCB of the final package together with the control logic circuit 101. In order to control the MEMS device 104, connection between the control logic circuit 101 and the MEMS device 104 is necessary. The bonded wires 102 between the control logic circuit 101 and the MEMS device 104 supply control signals and power to MEMS device 104. Separate wire bonding 105, especially grounding can be carried out to supply independent power or signal to the MEMS device 104. For control by a PC or a controller, external wire bonding or PCB package connection can be implemented to supply control signal data and power from external source and controller.

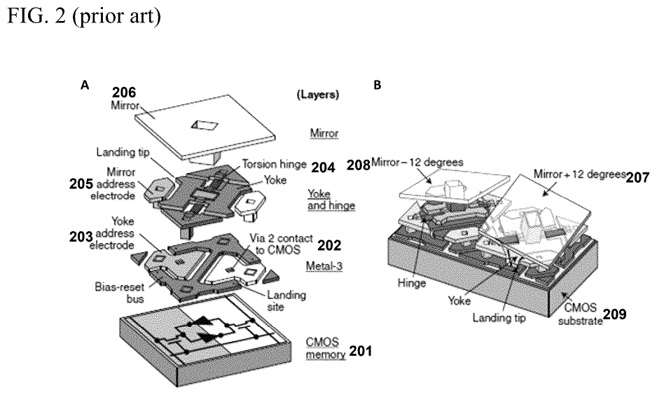

FIG. 2A (prior art) shows a layer schematic diagram of the DMD device from Texas Instrument. First CMOS memory 201 is built through standard semiconductor process. Then micromirror structures (yoke address electrodes 203, torsion hinge 204, mirror address electrodes 205, and mirrors 206) were built on top of the CMOS memory structures. The yoke address electrodes 203 and mirror address electrodes 205 are electrically connected to the CMOS memory through Via 202.

FIG. 2B (prior art) shows structure of Texas Instrument DMD device operation schematics. The individual micromirrors are operated with +/−12 degree rotation 207, 208 through the applied voltage from the CMOS substrate 209. Also the hinge structure 204 gives torsional restoration force for coming back to the original position.

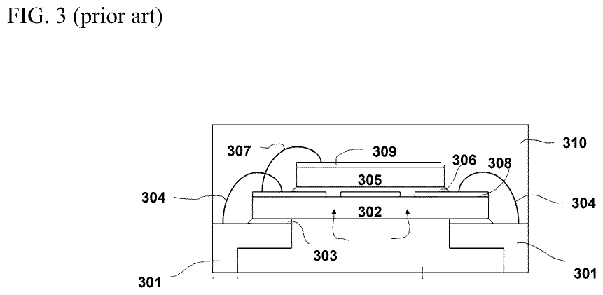

FIG. 3 (prior art) shows multi-stacked MEMS device and its wire connection to outside control logics. On top of the outside circuitry (maybe PCB) 301, first MEMS device 302 is stacked with first epoxy layer 303 with insulation pads. First stage wire-boning 304 comes from on top of the first MEMS device 302 to the outside circuitry 301. Second MEMS device 305 is attached with second epoxy layer 306 with insulation pads. Second stage wire-bonding 307 comes from on top of the second MEMS device 305. With this scheme, the first effective area 308 of the first MEMS device 302 and the second effective area 309 of the second MEMS device 305 can be exposed and used for optical applications. Finally, total device can be encapsulated with cover 310. With this scheme, effective area can be extended as well as increased number of the wire-bonding could be achieved. But the extended area is limited and increased number of the wire-bonding is also limited. Even large number of wire bonding is possible, the limited area gives limitation and large numbers of wires degraded yield of the device production.

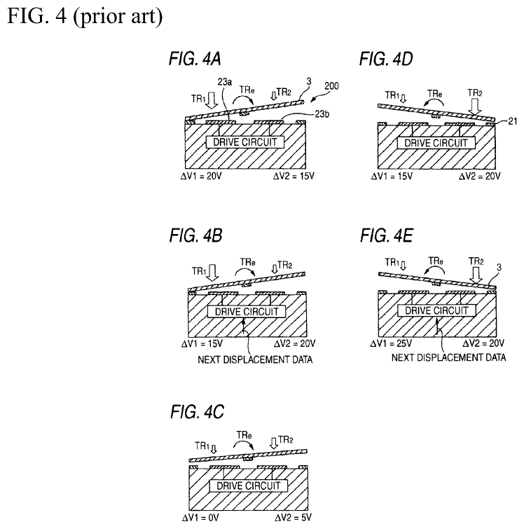

FIG. 4 (prior art) shows a method of direct control of multiple micromirrors just like in FIG. 2 disclosed in U.S. Pat. No. 7,304,782 issued Dec. 4, 2007 to Kimura. This gives more degrees of freedom motion for the micromirrors inside the array. Drive circuits are embedded inside the MEMS substrate. Basically the method for fabricating the micromirror array is the same with the FIG. 2 DMD case as making CMOS driving circuit in the MEMS substrate and then building MEMS structures on top of the substrate.

As described in the above, increasing degrees of freedom and independently tunable micromirror array devices are being studied and developed for more than decades of time. Further examples of individually controlled micromirror device is Micromirror Array Lens. The general properties of the Micromirror Array Lens are disclosed in U.S. Pat. No. 7,173,653 issued Feb. 6, 2007 to Gim, U.S. Pat. No. 7,215,882 issued May 8, 2007 to Cho, U.S. Pat. No. 7,354,167 issued Apr. 8, 2008 to Cho, U.S. Pat. No. 9,565,340 issued Feb. 7, 2017 to Sco, U.S. Pat. No. 7,236,289 issued Jun. 26, 2007 to Back, U.S. Pat. No. 9,736,346 issued Aug. 15, 2017 to Back, all of which are incorporated herein by references.

The general principle, methods for making the micromirror array devices and Micromirror Array Lens, and their applications are disclosed in U.S. Pat. No. 7,057,826 issued Jun. 6, 2006 to Cho, U.S. Pat. No. 7,339,746 issued Mar. 4, 2008 to Kim, U.S. Pat. No. 7,077,523 issued Jul. 18, 2006 to Sco, U.S. Pat. No. 7,068,416 issued Jun. 27, 2006 to Gim, U.S. Pat. No. 7,333,260 issued Feb. 19, 2008 to Cho, U.S. Pat. No. 7,315,503 issued Jan. 1, 2008 to Cho, U.S. Pat. No. 7,768,571 issued Aug. 3, 2010 to Kim, U.S. Pat. No. 7,261,417 issued Aug. 28, 2007 to Cho, U.S. Pat. Pub. No. 2006/0203117 A1 published Sep. 14, 2006 to Sco, U.S. Pat. Pub. No. 2007/0041077 A1 published Feb. 22, 2007 to Sco, U.S. Pat. Pub. No. 2007/0040924 A1 published Feb. 22, 2007 to Cho, U.S. Pat. No. 7,742,232 issued Jun. 22, 2010 to Cho, U.S. Pat. No. 8,049,776 issued Nov. 1, 2011 to Cho, U.S. Pat. No. 7,350,922 issued Apr. 1, 2008 to Sco, U.S. Pat. No. 7,605,988 issued Oct. 20, 2009 to Sohn, U.S. Pat. No. 7,589,916 issued Sep. 15, 2009 to Kim, U.S. Pat. Pub. No. 2009/0185067 A1 published Jul. 23, 2009 to Cho, U.S. Pat. No. 7,605,989 issued Oct. 20, 2009 to Sohn, U.S. Pat. No. 8,345,146 issued Jan. 1, 2013 to Cho, U.S. Pat. No. 8,687,276 issued Apr. 1, 2014 to Cho, U.S. Pat. Pub. No. 2018/064562 A1 published Jun. 14, 2018 to Bycon, U.S. Pat. Pub. No. 2019/0149795 A1 published May 16, 2019 to Sohn, U.S. Pat. Pub. No. 2019/0149804 A1 published May 16, 2019 to Sohn, U.S. Pat. Pub. No. 2020/0341260 A1 published Oct. 29, 2020 to Gaiduk, U.S. Pat. No. 11,378,793 issued Jul. 5, 2022 to Winterot, U.S. Pat. No. 11,940,609 B2 issued Sep. 11, 2024 to Gaiduk, all of which are incorporated herein by references.

The general principle, structure and methods for making the discrete motion control of MEMS device are disclosed in U.S. Pat. No. 7,330,297 issued Feb. 12, 2008 to Noh, U.S. Pat. No. 7,365,899 issued Apr. 29, 2008 to Gim, U.S. Pat. No. 7,382,516 issued Jun. 3, 2008 to Sco, U.S. Pat. No. 7,400,437 issued Jul. 15, 2008 to Cho, U.S. Pat. No. 7,411,718 issued Aug. 12, 2008 to Cho, U.S. Pat. No. 7,474,454 issued Jan. 6, 2009 to Sco, U.S. Pat. No. 7,488,082 issued Feb. 10, 2009 to Kim, U.S. Pat. No. 7,535,618 issued May 19, 2009 to Kim, U.S. Pat. No. 7,898,144 issued Mar. 1, 2011 to Sco, U.S. Pat. No. 7,777,959 issued Aug. 17, 2010 to Sohn, U.S. Pat. No. 7,589,884 issued Sep. 15, 2009 to Sohn, 2006, U.S. Pat. No. 7,589,885 issued Sep. 15, 2009 to Sohn, U.S. Pat. No. 7,605,964 issued Oct. 20, 2009 to Gim, and U.S. Pat. No. 9,505,606 issued Nov. 29, 2016 to Sohn, all of which are incorporated herein by references.

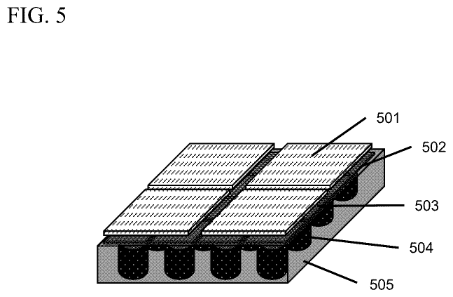

FIG. 5 shows the schematic example of the micromirror array device including micromirrors 501, actuators 502, electrodes 503, substrates 505, and TSVs 504 with square type micromirrors. With square type micromirrors 501, the electrodes 503 can be arranged also in square array. This gives a good advantage to make the ASIC electrodes in the same manner and gives advantage for addressing of the micromirrors 501 and the electrodes 503 for the actuators 502 to control micromirrors 501.

In FIG. 5, four micromirrors 501 are shown for the array of the micromirrors 501 to give a brief schematic arrangement. And under the individual micromirrors 501, four electrodes 503 and four actuators 502 (not drawn separately) are located. Each of the four actuators 502 can be controlled individually with the electrodes 503 connected with the individual actuators 502. To generate the multiple (2 or 3) degrees of freedom motion of the micromirrors 501, at least the same numbers of the independently controlled actuators 502 are required here. Given four electrodes 503 (actuators 502) assigned to individual micromirrors 501 can generate the multiple degrees of freedom motion for the individual micromirrors 501.

The connecting means, here TSVs 504 (Through Silicon Via) are shown as an example. TSVs can be fabricated under the electrodes 503 through the silicon wafer substrate 505, matching the MEMS electrodes 503 with the ASIC electrodes with one to one correspondence. Thus the generated control voltages from the ASIC electrodes can be delivered to the MEMS electrodes 503 and the individual actuators 502 can be operated independently to make individually tunable micromirror 501 motion for the freeform variable focusing lens.

TSVs 504 can be built with via first process, wherein the structures for the micromirrors 501 and the actuators 502 are fabricated after the via making process. Also TSVs 504 can be built after fabricating the structures for the micromirrors 501 and the actuators 502. Either way works for fabricating the present invention of the freeform variable focusing lens with ASIC control integrated micromirror array. Here TSVs 504 are shown as an example of the invention with the silicon MEMS processes. Other connecting means can be utilized to connect the ASIC electrodes to the MEMS electrodes. Also here only square type micromirror arrangement is given as an example, rectangular type of micromirror arrangement can be used for the freeform variable focusing lens.

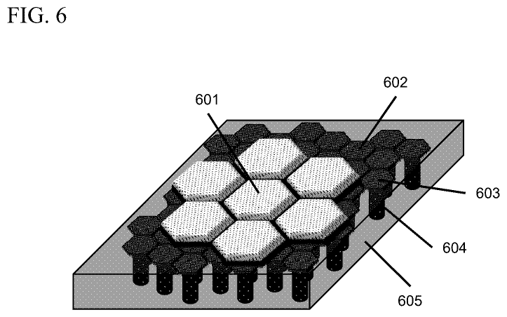

FIG. 6 shows the schematic example of the micromirror array device including micromirrors 601, actuators 602, electrodes 603, substrates 605, and TSVs 604 with hexagonal type micromirrors. With hexagonal type micromirrors 601, the electrodes 603 can be arranged also in hexagonal array. Since hexagonal array can form honeycomb structure in two dimension, this gives a good advantage to use area more effectively and can make TSVs closest with each other to utilize the area of the device. Even the micromirrors 601, the actuators 602, and the electrodes 603 are not arranged in rectangular array, the addressing for the device can be implemented similar way as the micromirror array case in square and rectangular arrangement cases. The ASIC electrodes can be arranged in the same manner as the micromirror 601 array actuators 602 and the micromirror array electrodes 603 to control the micromirrors 601 in the micromirror array device.

In FIG. 6, seven micromirrors 601 are shown for the array of the micromirrors 601 to give a brief schematic arrangement. And under the individual micromirrors 601, four electrodes 603 and four actuators 602 (not drawn separately) are located. Each of the four actuators 602 can be controlled individually with the electrodes 603 connected with the individual actuators 602. To generate the multiple (2 or 3) degrees of freedom motion of the micromirrors 601, at least the same numbers of the independently controlled actuators 602 are required. Given four electrodes 603 (actuators 602) (one in center of the micromirror and three around the center electrode) assigned to individual micromirrors 601 can generate the multiple degrees of freedom motion for the individual micromirrors 601. Four electrodes 603 in the honeycomb structures can be arranged with hexagonal micromirror arrangement. Also electrodes 603 can be arranged in honeycomb structure as micromirrors 601. One electrode 603 can be aligned with the center of the individual micromirrors 601 and three other electrodes 603 around the center electrode 603 can be assigned to the micromirror 601 with center electrode 603. And the other three electrodes 603 can be assigned to the neighboring micromirrors 601.

The connecting means, here TSVs 604 (Through Silicon Via) are shown as an example. TSVs can be fabricated under the electrodes 603 through the silicon wafer substrate 605, matching the MEMS electrodes 603 with the ASIC electrodes with one to one correspondence. Thus the generated control voltages from the ASIC electrodes can be delivered to the MEMS electrodes 603 and the individual actuators 602 can be operated independently to make individually tunable micromirror 601 motion for the freeform variable focusing lens.

TSVs 604 can be built with via first process, wherein the structures for the micromirrors 601 and the actuators 602 are fabricated after the via making process. Also TSVs 604 can be built after fabricating the structures for the micromirrors 601 and the actuators 602. Either way works for fabricating the present invention of the freeform variable focusing lens with ASIC control integrated micromirror array. Here TSVs 604 are shown as an example of the invention with the silicon MEMS processes. Other connecting means can be utilized to connect the ASIC electrodes to the MEMS electrodes.

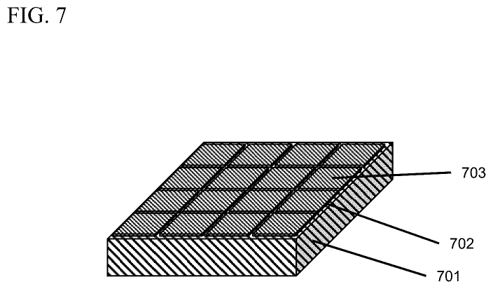

FIG. 7 shows the schematic example of the ASIC device having same area with the micromirror array device shown in FIG. 5. The micromirrors here are arranged with square type micromirrors just as shown in FIG. 5. It would be easier to arrange ASIC electrodes 703 with the same geometry with the MEMS electrodes in FIG. 5. But without matching the ASIC electrodes 703 and the MEMS electrodes, the electrodes can be aligned together with routing structures on one side (micromirror array device or ASIC device) or on both sides.

In FIG. 7, ASIC electronics (not shown in the figure) 702 are firstly built on top of the silicon substrate 701. These electronics 702 contain a plurality of switches for operating each ASIC electrode 703 independently. To make the operation simple, the electrodes 703 are controlled vertically and horizontally with the row drivers and the column drivers. To support switching the electrodes 703 and other operation, the ASIC device further implements timing controller, memory, and interfaces for external communication.

On top of the silicon substrate 701, electronics 702 (not shown in the figure) for the ASIC is built, wherein the required structures are pre-built. After the electronics 702 is built, the ASIC electrodes 703 are arranged to match with the electrodes 503 in the micromirror array device. Some routing structure can also be built to match the arrangement. And on top of the ASIC electrodes 703, there will be structures for the wafer bonding and getting connection between the ASIC electrodes 703 and the MEMS electrodes 503 in the micromirror array device.

In FIG. 7, the ASIC electrodes are arranged with square which is the same configuration of the FIG. 5 square type arrangement. This square type electrode arrangement is easier for addressing the electrodes thus the micromirrors in the micromirror array device. Also in similar way, rectangular arrangement can be achieved.

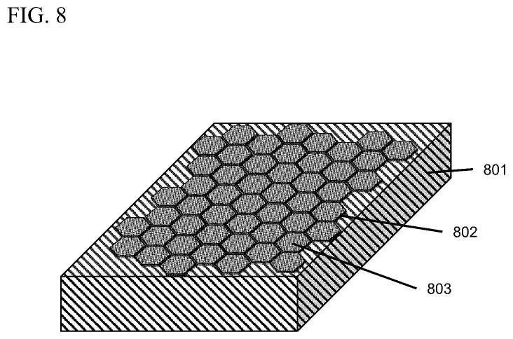

FIG. 8 shows the schematic example of the ASIC device having the same area with the micromirror array device shown in FIG. 6. The micromirrors here are arranged with hexagonal type micromirrors just like the FIG. 6. It would be easier to utilize ASIC electrodes arrangement with denser configuration thanks to the honeycomb structure with the same geometry with the MEMS electrodes in FIG. 6. But without matching the ASIC electrodes 803 and the MEMS electrodes 603 in FIG. 6, the electrodes can be aligned together with routing structures on one side (micromirror array device or ASIC device) or both side. These honeycomb structure electrodes can be rearranged with rectangular shape array and then configured with the electrodes in the micromirror array device.

In FIG. 8, ASIC electronics (not shown in the FIG. 802 are firstly built on top of the silicon substrate 801. These electronics 802 contain a plurality of switches for operating each ASIC electrode 803 independently. To make the operation simple, the electrodes 803 are controlled vertically and horizontally with the row drivers and the column drivers. To support switching the electrodes 803 and other operations, the ASIC device further implements timing controller, memory, and interfaces for external communication.

On top of the silicon substrate 801, electronics 802 (not shown in the figure) for the ASIC is built, wherein the required structures are pre-built. After the electronics 802 are built, the ASIC electrodes 803 are arranged to match with the electrodes 603 in the micromirror array device. Some routing structure can also be built to match the arrangement. And on top of the ASIC electrodes 803, there will be structures for the wafer bonding and getting connection between the ASIC electrodes 803 and the MEMS electrodes 603 in the micromirror array device. Especially when used hexagonal micromirror arrangement, with routing

In FIG. 8, the ASIC electrodes are arranged with hexagon which is the same configuration of the FIG. 6 hexagonal arrangement. This hexagonal type electrode arrangement has an advantage with higher density of TSVs thanks to the hexagonal closed pack structure of the TSV structure. Also with simple routing, it can be converted into rectangular shape arrangement, which is easily configured to control with vertical and horizontal arrangement.

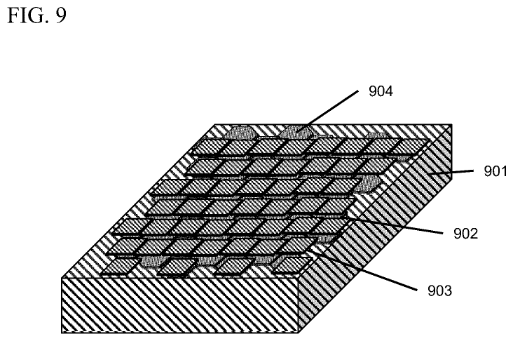

FIG. 9 shows the schematic example of the ASIC device having same area with the micromirror array device as shown in FIG. 6. The micromirrors here are arranged with hexagonal type micromirrors just like the FIG. 6 but the electrode itself does not have hexagonal shape rather than square type electrodes. It would be easier to utilize ASIC electrodes arrangement with denser configuration thanks to the honeycomb (hexagonal) structure with the same geometry with the MEMS electrodes in FIG. 6 and the square type electrodes can be easily made in electronics design.

In FIG. 9, ASIC electronics (not shown in the FIG. 902 are firstly built on top of the silicon substrate 901. These electronics 902 contain a plurality of switches for operating each ASIC electrode 903 independently. To make the operation simple, the electrodes 903 are controlled vertically and horizontally with the row drivers and the column drivers. To support switching the electrodes 903 and other operation, the ASIC device further implements timing controller, memory, and interfaces for external communication.

On top of the silicon substrate 901, electronics 902 (not shown in the figure) for the ASIC is built, wherein the required structures are pre-built. After the electronics 902 are built, the ASIC electrodes 903 are arranged to match with the electrodes 603 in the micromirror array device. Some routing structure can also be built to match the arrangement. And on top of the ASIC electrodes 903, there will be structures for the wafer bonding and getting connection between the ASIC electrodes 903 and the MEMS electrodes 603 in the micromirror array device with routing especially when used with hexagonal micromirror arrangement.

In FIG. 9, the ASIC electrodes have square type electrodes while the arrangement is hexagonal like in the FIG. 6. This hexagonal type electrode arrangement has an advantage with higher density of TSVs thanks to the hexagonal closed pack structure of the TSV structure. Also with simple routing, it can be converted into rectangular shape arrangement, which is easily configured to control with vertical and horizontal arrangement.

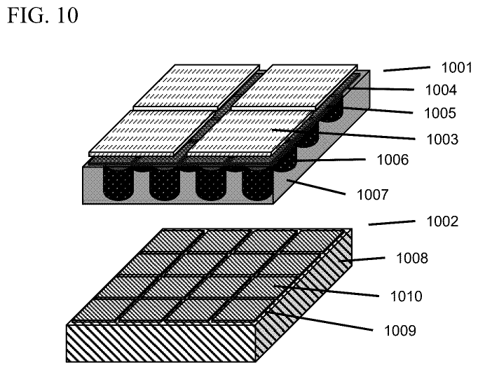

FIG. 10 shows the micromirror array device 1001 and the ASIC device 1002 together with square type micromirrors 1003 and MEMS electrodes 1005. All the structures are the same as in FIG. 5 and FIG. 7. The micromirror array device 1001 was built with MEMS electrodes 1005 and actuators 1004 on the MEMS substrate. TSVs 1006 can be built with via first process or the TSVs 1006 can be built after the micromirror structures are built.

The ASIC device 1002 is pre-built with electronics 1009 and ASIC electrodes 1010 on top of the ASIC electronics 1007 on the ASIC substrate 1008 as shown in FIG. 7 in detail.

The MEMS electrodes 1007 in the micromirror array device 1001 and the ASIC electrodes 1010 in the ASIC device 1002 are arranged with the same geometry to match with each other through the TSV 1006 structures to connect each other. The ASIC device 1002 generates the control voltages and deliver the control voltages from the ASIC electrodes 1010 to MEMS electrodes 1005 through the TSVs 1006. Thus the actuators 1004 in the micromirror array device 1001 are operated and finally the micromirrors 1003 in the micromirror array device 1001 can have its own individual micromirror 1003 motions. And these micromirrors 1003 collectively generate an optical surface profile with optical properties like focal length of the optical system. And the optical surface profiles can be controlled for varying optical properties. The freeform variable focusing lens can be built and operated with control of ASIC device 1002 which generates control voltages for the micromirror array device 1001 thus changes the optical surface profiles of the freeform variable focusing lens device.

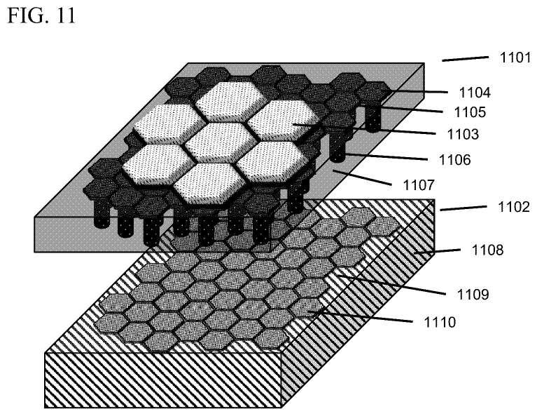

FIG. 11 shows the micromirror array device 1101 and the ASIC device 1102 together with hexagonal type micromirrors 1103 and MEMS electrodes 1105. All the structures are the same as shown in FIG. 6 and FIG. 8. The micromirror array device 1101 was built with MEMS electrodes 1105 and actuators 1104 on the MEMS substrate. TSVs 1106 can be built with via first process or the TSVs 1106 can be built after the micromirror structures are built.

The ASIC device 1102 is pre-built with electronics 1109 and ASIC electrodes 1110 on top of the ASIC electronics 1109 on the ASIC substrate 1108 as shown in FIG. 8 in detail. The ASIC electrodes 1110 are arranged with hexagonal array as well as the MEMS electrodes 1105 and the micromirrors 1103 in the micromirror array device 1101.

The MEMS electrodes 1107 in the micromirror array device 1101 and the ASIC electrodes 1110 in the ASIC device 1102 are arranged with the same geometry to match with each other through the TSV 1106 structures to connect each other. Those are arranged in honeycomb structure and shaped as hexagonal type. The ASIC device 1102 generates the control voltages and deliver the control voltages from the ASIC electrodes 1110 to MEMS electrodes 1105 through the TSVs 1106. Thus the actuators 1104 in the micromirror array device 1101 are operated and finally the micromirrors 1103 in the micromirror array device 1101 can have its own individual micromirror 1103 motions. And these micromirrors 1103 collectively generate an optical surface profile with optical properties like focal length of the optical system. And the optical surface profiles can be controlled for varying optical properties. The freeform surface variable focusing lens can be built and operated with control of ASIC device 1102 which generates control voltages for the micromirror array device 1101 thus changes the optical surface profiles of the freeform variable focusing lens device. This time the optical surface profiles are generated with hexagonal shape micromirrors 1103 in the micromirror array device 1101.

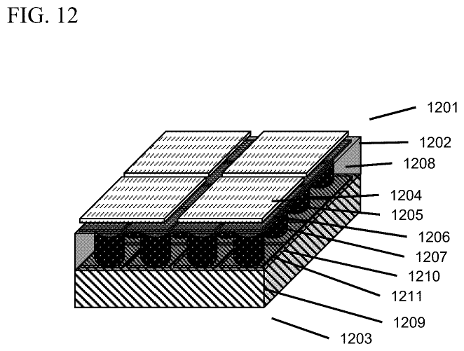

FIG. 12 illustrates the bonded structure of the micromirror array device 1202 and the ASIC device 1203 and arranged with square shape micromirror 1204 geometry wherein the MEMS electrodes 1207 and the ASIC electrodes 1212 are aligned with each other. FIG. 12 shows the wafer bonded freeform variable focusing lens device 1201. The freeform surface variable focusing lens device 1201 has two devices bonded together with wafer bonding technology. One is the micromirror array device 1202 having micromirrors 1204, actuators 1205, MEMS electrodes 1206 and TSVs 1207 on the MEMS substrate 1208 and the other is the ASIC device 1203 having ASIC substrate 1209, electronics (not shown) 1210, and ASIC electrodes 1211 together with square type micromirrors 1204 and MEMS electrodes 1206. All the structures are the same as in FIG. 5, FIG. 7, and FIG. 9.

The wafer bonded structures (the freeform surface variable focusing lens device 1201) in wafer level are diced. The structures should be diced separately for the micromirror array device 1202 and the ASIC device 1203. Especially the ASIC device 1203 should have the exposed electro-pads for the external connections for the data and command communication and the power supply. The process for making device with the split dicing is disclosed in U.S. patent application Ser. No. 18/394,866 by Hong, which is incorporated herein by references.

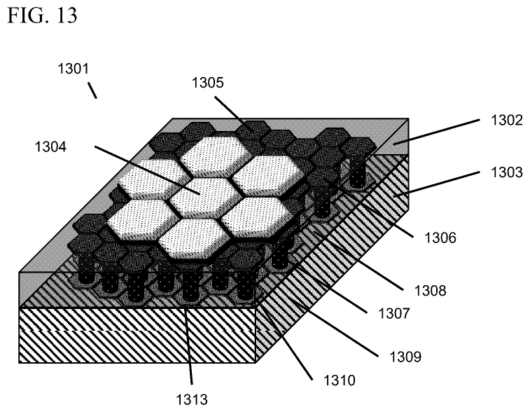

FIG. 13 illustrates the bonded structure of the micromirror array device 1302 and the ASIC device 1303 and arranged with hexagonal shape micromirror 1304 geometry wherein the MEMS electrodes 1307 and the ASIC electrodes 1312 are aligned with each other. FIG. 13 shows the wafer bonded freeform variable focusing lens device 1301. The freeform surface variable focusing lens device 1301 has two devices bonded together with wafer bonding technology. One is the micromirror array device 1302 having micromirrors 1304, actuators 1305, MEMS electrodes 1306 and TSVs 1307 on the MEMS substrate 1308 and the other is the ASIC device 1303 having ASIC substrate 1309, electronics (not shown) 1310, and ASIC electrodes 1311 together with hexagonal type micromirrors 1304 and MEMS electrodes 1306. All the structures are the same as in FIG. 6, FIG. 8, and FIG. 11.

The wafer bonded structures (the freeform surface variable focusing lens device 1301) in wafer level are diced. The structures should be diced separately for the micromirror array device 1302 and the ASIC device 1303. Especially the ASIC device 1303 should have the exposed electro-pads for the external connections for the data and command communication and the power supply. The ASIC device 1303 has two sections of the ASIC electrodes 1312 and the electro-pads for communication. The ASIC electrodes are for the micromirror array device and the electro-pads are for communication to the external devices, such as MCU, computer through communication protocols. The process for making device with the split dicing is for exposing the exposed electro-pads disclosed in U.S. patent application Ser. No. 18/394,866 by Hong, which is incorporated herein by references.

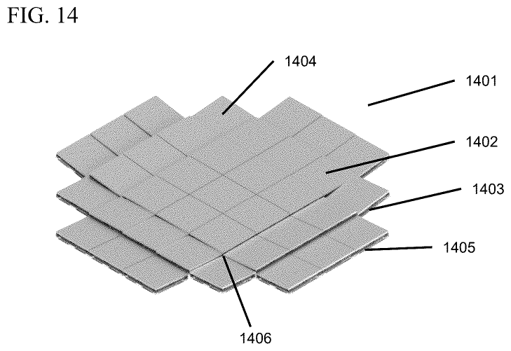

FIG. 14 shows an example of surface profile 1406 for the present invention of the freeform surface variable focusing lens 1401. To generate the surface profile 1406, first the ASIC device 1403 receives control signal from outside (MCU or CPU from computer). Second, the ASIC device 1403 translates the control commands to generated data for the surface profile 1406 or read from the memory of the ASIC device 1403 (internal or external). Based on the surface profile 1406 data, the ASIC device 1403 generates the control voltages of the individual ASIC electrodes while generating the column and the row drivers switch the row and the column data for the whole frame of the data.

After generating the control voltages for the actuators in the micromirror array device 1402, the control voltages are transferred through the TSVs to the MEMS electrodes in the micromirror array device 1402. Finally, individual actuators 1405 are operated with the control voltages and generate motions of the individual micromirrors 1404. These individual micromirror 1404 motions generate the freeform optical surface profile 1406 and the optical surface profiles 1406 are generating the optical properties of the optical system. And by control commands from MCU or CPU, the ASIC device 1403 generates multiple optical surface profiles 1406 to have variable optical properties of the micromirror array device 1402.

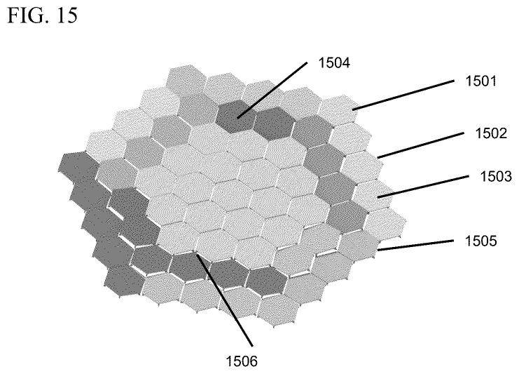

FIG. 15 shows an example of surface profile 1506 for the present invention of the freeform surface variable focusing lens 1501. Differently from the case of the FIG. 14, the surface profile is generated with hexagonal micromirrors. Different addressing for the device and geometry is applied for the system. To generate the surface profile 1506, first the ASIC device 1503 receives control signal from outside (MCU or CPU from computer). Second, the ASIC device 1503 translates the control commands to generated data for the surface profile 1506 or read from the memory of the ASIC device 1503 (internal or external). Based on the surface profile 1506 data, the ASIC device 1503 generates the control voltages of the individual ASIC electrodes while generating the column and row drivers switch the row and the column data for the whole frame of the data.

After generating the control voltages for the actuators in the micromirror array device 1502, the control voltages are transferred through the TSVs to the MEMS electrodes in the micromirror array device 1502. Finally, individual actuators 1505 are operated with the control voltages and generate motions of the individual micromirrors 1504. These individual micromirror 1504 motions generate the freeform optical surface profile 1506 and the optical surface profiles 1506 are generating the optical properties of the optical system. And by control commands from MCU or CPU, the ASIC device 1503 generates multiple optical surface profiles 1506 to have variable optical properties of the micromirror array device 1502.

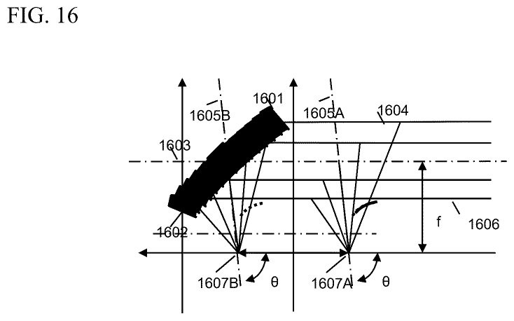

FIG. 16 shows a schematic illustration for forming optical surface profile with the freeform surface variable focusing lens 1601. The freeform surface variable focusing lens 1601 comprising micromirrors 1602 positioned obliquely with respect to an optical axis 1603 of an optical system. The micromirror array device 1601 reproduces an off-axis parabolic freeform surface 1604 as an example. The optical axis 1603, 1605A, 1605B of the system is tilted with an amount of angle θ. The conventional off-axis parabolic freeform surface 1604 makes all incident lights 1606 parallel with the optical axis 1603 of the paraboloid be focused into a focal point 1607A. The freeform surface variable focusing lens 1601 reproduces the off-axis parabolic freeform surface 1604, wherein the micromirrors 1602 are configured to reflect the incident light 1606 into the focal point 1607B as the continuous conventional paraboloid 1604 does. The optical surface profile 1604 of the freeform surface variable focusing lens 1601 is further recalibrated to satisfy the phase matching condition along with the convergence condition. To satisfy the converge condition the individual micromirrors in the optical surface profile have the angle of tilt motion (two degrees of freedom rotation motion) and for phase matching condition, the individual micromirrors in the freeform surface variable focusing lens uses piston motion (one degree of freedom translation motion) independently. More detail for generating the optical surface profile is disclosed in U.S. Pat. No. 7,619,807 issued Nov. 17, 2009 to Back, which is incorporated herein by references.

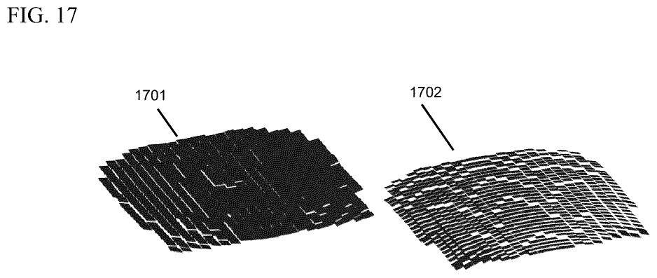

FIG. 17 illustrates the optical surface profiles of the variable focusing lens wherein the freeform variable focusing lens with ASIC control integrated micromirror array represent a parabolic surface shapes to focus with 45-degree of incident angle to the optical surface. One is concave type optical surface profile and the other is convex type of the optical surface profile. Both can tune the focal length of the parabolic mirror. Concave type optical surface profile gives longer focal length of the parabolic surface shape and the convex type optical surface profile gives shorter focal length of the parabolic surface than that of flat surface optical surface profile in the optical system. Also an example of the present invention of the freeform variable focusing lens with ASIC control integrated micromirror array is disclosed in U.S. patent application Ser. No. 18/384,721 filed Oct. 26, 2023 to Sohn, which is incorporated herein by references

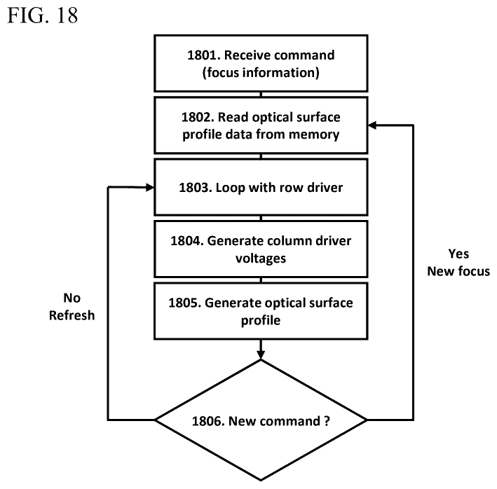

FIG. 18 illustrates control steps of the freeform variable focusing lens with ASIC control integrated micromirror array operation, generating optical surface profiles and foci. Before the freeform variable focusing lens with ASIC control integrated micromirror array is operated, the freeform variable focusing lens has its optical surface profile data in a memory. After initialization process, the freeform variable focusing lens with ASIC control integrated micromirror array receives command 1801 for setting (or changing) the focus of the freeform variable focusing lens. The command can be simple with address in the memory for the optical surface profile. Then the ASIC device reads the optical surface profile data 1802 from the memory. The data is written in control voltages of the micromirror array device actuators. After reading the optical surface data, the surface frame is generated row by row. Column drivers generate all the voltages 1804 of the column drivers for a row at the same time. Each row has one set of column driver voltages. Row drivers scan with sets of the column drivers. After whole scan of the row drivers, the optical surface profile is generated 1805. While looping (scanning) of the row drivers 1803, new command for changing focus 1806 can be received. If new command for changing focus is received, the process is resumed with reading the optical surface profile data from memory. If new command for changing focus is not received, the process is resumed with looping the row drivers for refreshing the frame data for the optical surface profile. This process is continuously repeated until pause command is received or stop the process command is performed.

The present invention of the freeform variable focusing lens with ASIC control integrated micromirror array comprises a micromirror array device forming reflective type freeform optical surfaces with variable focusing property wherein the micromirror array device comprises a plurality of micromirrors wherein the micromirrors are arranged in an array and said each micromirror have at least two actuators with individually and independently controlled electrodes, a substrate for the micromirror array device wherein the said substrate has a plurality of MEMS electrodes to operate the individual actuators, and a plurality of connecting means connected through the substrate from one side of the substrate (where the micromirrors are present) to the other side of the substrate to deliver control voltages of the electrodes.

The present invention of the freeform variable focusing lens with ASIC control integrated micromirror array also comprises an ASIC (Application-Specific Integrated Circuit) device generating the control voltages of the actuators in the micromirror array device comprising a plurality of ASIC electrodes wherein the plurality of the ASIC electrodes provides control voltages to the actuators in the micromirror array device through the plurality of the connecting means in the substrate of the micromirror array device, a plurality of column drivers to generate control voltages through DACs (Digital to Analog Converter) and determine voltages for the part of the plurality of the ASIC electrode, a plurality of row drivers to time scan for the optical surface data, wherein the row drivers deliver the control voltages from the column drivers to the plurality of the ASIC electrodes with timed switching method, a timing controller generating timing signals for the column drivers and the row drivers to provide the control voltages to the plurality of the ASIC electrodes, high voltage amplifiers generating high voltages enough for operating the actuators in the micromirror array device, external connections providing the freeform optical surfaces in the control voltage format data and providing power supplies to the ASIC device, and a memory device for data storage of the freeform optical surfaces to operate as a variable focusing lens.

The present invention of the freeform variable focusing lens with ASIC control integrated micromirror array comprises a micromirror array device and an ASIC device wherein the micromirror array device and the ASIC device are bonded together while fabricating and wherein the control voltages are delivered from the plurality of the ASIC electrodes to the plurality of the MEMS electrodes through the connecting means in the substrate for the plurality of the micromirrors, the ASIC electrodes and the MEMS electrodes have correspondence to control the individual micromirrors in the micromirror array device.

In the present invention of the freeform variable focusing lens with ASIC control integrated micromirror array, wherein the substrate of the micromirror array device and the ASIC device is wafer-bonded during fabrication and diced after bonding. The plurality of the micromirrors have multiple degrees of freedom of motion independently wherein the micromirrors have at least the same number of actuators in the individual micromirror. The connecting means in the substrate of the micromirror array device are built with TSV (through silicon via) technology. The connecting means have honeycomb structure to have higher density of the connecting means in the substrate of the micromirror array device.

The present invention of the freeform variable focusing lens with ASIC control integrated micromirror array comprises a plurality of the MEMS electrodes wherein the MEMS electrodes have one-to-one correspondence with the actuators in the micromirror array device. The MEMS electrodes and the ASIC electrodes have one-to-one correspondence to deliver the control voltages from the ASIC device to the micromirror array device.

The present invention of the freeform variable focusing lens with ASIC control integrated micromirror array comprises a plurality of the actuators in the micromirror array device are actuated with electrostatic force.

The present invention of the freeform variable focusing lens with ASIC control integrated micromirror array with an ASIC device comprises row and column as the number of the row drivers and the number of the column drivers. The row drivers scan progressively every row in order. The row drivers scan interlaced to have less delay between frames. The memory device for data storage can be placed outside of the ASIC device, wherein the outside memory device for data storage can be accessed from the ASIC device directly. The memory device stores multiples of optical surface profile data and selected data is transferred the ASIC device and then the micromirror array device to have actual optical surfaces with the micromirrors.

The present invention of the freeform variable focusing lens with ASIC control integrated micromirror array with an ASIC device comprises a plurality of optical profiles with varying control voltages through the ASIC device. The optical profiles satisfy focusing condition and phase-matching condition to form lens surfaces and said each optical surface profile corresponds to the different focal length of the optical system where the freeform variable focusing lens with ASIC control integrated micromirror array is used. The freeform optical surfaces are changed with control thus the focal length of the freeform variable focusing lens changes wherein the optical surface control voltages are generated by the ASIC device. The optical surface profile can have other than optical surface profiles with circular symmetry.

The present invention of the freeform variable focusing lens with ASIC control integrated micromirror array comprises a micromirror array device and an ASIC device wafer-bonded while being fabricated. The present invention of the freeform variable focusing lens comprises a micromirror array device wherein the micromirror array comprises a plurality of the micromirrors wherein the micromirrors in the micromirror array are independently controlled having multiple degrees of freedom motion (at least two degree of freedom motion). The multiple degrees of freedom motion is implemented with multiple actuators under the micromirrors. To have independently control, each micromirror in the micromirror array has multiple actuators and multiple electrodes wherein the multiple actuators and the electrodes have independent control voltages.

The present invention of the freeform variable focusing lens comprises an ASIC device wherein the ASIC device comprises a plurality of ASIC electrodes wherein the plurality of the ASIC electrodes provides control voltages to the actuators in the micromirror array device through the plurality of the connecting means in the substrate of the micromirror array device. A plurality of column drivers generate control voltages through DACs with control commands at the same time and determine voltages for the part of the plurality of the ASIC electrodes. A plurality of row drivers to time-scan for the optical surface data row by row, wherein the row drivers deliver the control voltages from the column drivers to the plurality of the ASIC electrodes with timed switching method row by row. A timing controller generating timing signals for the column drivers and the row drivers to provide the control voltages to the plurality of the ASIC electrodes. High voltage amplifiers generating high voltages enough to operate the MEMS actuators in the micromirror array device based on DACs control voltages in the column drivers. Each ASIC electrode has a high voltage switch operated by the column drivers and the row drivers. The high voltage switch has the voltage maintaining circuit to hold the control voltage while the row driver scan is progressing. The row voltage drivers can perform progressively or interlaced scan for better performance.

Also the ASIC device has the memory for storing the control voltage data for the optical surface profiles. The memory for storing the optical surface profile data can be internal or external. For external memory, the ASIC device should have proper data transferring interfaces to match with the scan speed of the ASIC device.

Each electrode in the ASIC device can have different voltages and independently set with control voltages, wherein the set of the control voltages is generated for said each ASIC electrode. The voltages in the ASIC electrodes are preset for the desired optical surface profiles. Since the individual ASIC electrodes can have independent control and setting, the optical surface profiles can be controlled to have individual control ability for said each actuator and said each micromirror. Thus the micromirror array device can generate the freeform surface without any restriction for the constraint. The present invention has a critical advantage for the control ability of the surface profile with high number of the individual control. With the present invention scheme, more than tens of thousands of individual controls can be possible. Thanks to the individual control ability of the ASIC electrodes and the individual MEMS actuators, the micromirror array device forms the freeform optical surface profile without any restriction. With the refresh and renewing the control voltages in frames, also multiple optical surface profiles can be updated and controlled by the ASIC device. With time-dependent control of the optical surface profiles, the present invention of the freeform variable focusing lens with ASIC control integrated micromirror array can change the properties of the optical surface profiles thus change of the optical properties of the micromirror array device.

The present invention of the freeform variable focusing lens with ASIC control integrated micromirror array also comprises optical surface profiles for lens surfaces. With changing lens surface profiles, the present invention of the micromirror array device can have the multiple time varying focusing property. With the time varying optical surface profiles, the present invention of the freeform variable focusing lens with ASIC control integrated micromirror array comprises multiple lens properties for the pre-designed focal length, aberration, and optical properties. The present invention of the freeform variable focusing lens with ASIC control integrated micromirror array can change its focus in the optical system with updating the surface profiles of the micromirror array device with control of the ASIC electrodes.

To have the lens surface profile with the micromirror array device, each micromirror is designed with two conditions. One is convergence condition and the other is phase matching condition. Each micromirror in the micromirror array device in an optical surface profile is controlled to satisfy the above lens surface constraints. To have better performance, the optical surface profile can compensate the optical aberration of the optical system also with individual control of the micromirrors in the micromirror array device.

For forming reflective type freeform optical surfaces with variable focusing property wherein the micromirror array device comprises a plurality of micromirrors wherein the micromirrors are arranged in an array and said each micromirror has at least two actuators with individually and independently controlled electrodes, a substrate for the micromirror array device wherein the said substrate has a plurality of MEMS electrodes to operate the individual actuators, and a plurality of connecting means connected through the substrate from one side of the substrate (where the micromirrors are present) to the other side of the substrate to deliver control voltages of the electrodes. The connecting means connect the ASIC electrodes and the MEMS electrodes individually.

The present invention of the freeform variable focusing lens with ASIC control integrated micromirror array comprises a micromirror array device and an ASIC device wherein the micromirror array device and the ASIC device are bonded together while fabricating and wherein the control voltages are delivered from the plurality of the ASIC electrodes to the plurality of the MEMS electrodes through the connecting means in the substrate for the plurality of the micromirrors, the ASIC electrodes and the MEMS electrodes have correspondence to control the individual micromirrors in the micromirror array device. The wafer bonding of the ASIC device and the MEMS micromirror array gives a good connection for the ASIC electrodes and the MEMS electrodes. Also since the ASIC device and the MEMS micromirror array device are separately fabricated, they did not suffer the difficulty of the process difference. First build the ASIC device and the MEMS micromirror array device in wafer level, separately. And then those wafers are wafer-bonded for electrical connections and diced for the operation later.

In the present invention of the freeform variable focusing lens with ASIC control integrated micromirror array, wherein the substrate of the micromirror array device and the ASIC device is wafer-bonded during fabrication and diced after bonding. The plurality of the micromirrors have multiple degrees of freedom motion independently wherein the micromirrors have at least the same number of actuators in the individual micromirror. The connecting means in the substrate of the micromirror array device are built with TSV (through silicon via) technology. The connecting means have honeycomb structure to have higher density of the connecting means in the substrate of the micromirror array device

The present invention of the freeform variable focusing lens with ASIC control integrated micromirror array comprises a plurality of the MEMS electrodes wherein the MEMS electrodes have one-to-one correspondence with the actuators in the micromirror array device. The MEMS electrodes and the ASIC electrodes have one-to-one correspondence to deliver the control voltages from the ASIC device to the micromirror array device.

The present invention of the freeform variable focusing lens with ASIC control integrated micromirror array comprises a plurality of the actuators in the micromirror array device are actuated with electrostatic force.

The present invention of the freeform variable focusing lens with ASIC control integrated micromirror array with an ASIC device comprises row and column as the number of the row drivers and the number of the column drivers. The row drivers scan progressively every row in order. The row drivers scan interlaced to have less delay between frames. The memory device for data storage can be placed outside of the ASIC device, wherein the outside memory device for data storage can be accessed from the ASIC device directly. The memory device stores multiples of optical surface profile data and selected data is transferred the ASIC device and then the micromirror array device to have actual optical surfaces with the micromirrors.

The present invention of the freeform variable focusing lens with ASIC control integrated micromirror array with an ASIC device comprises a plurality of optical profiles with varying the control voltages through the ASIC device. The optical profiles satisfy focusing condition and phase-matching condition to form lens surfaces and said each optical surface profile corresponds to the different focal length of the optical system where the freeform variable focusing lens with ASIC control integrated micromirror array is used. The freeform optical surfaces are changed with control thus the focal length of the freeform variable focusing lens changes wherein the optical surface control voltages are generated by the ASIC device. The optical surface profile can have other than optical surface profiles with circular symmetry.

With the present invention, the ASIC device has the capability of extending the numbers of the electrodes. Numbers of the electrodes can be more than 10 rows and 10 columns. Also the rows and columns of the ASIC device can range from 5 (below this number of connection, maybe direct control can be easier to fabricate) to thousands. The numbers can be determined by the size of total device, individual micromirror size, and speed of the device. The rows and columns of the ASIC electrodes can be at least 5 for both or can be at least 10 for both for the effectiveness of the present invention, which means at least 25 electrodes (100 electrodes) can be controlled directly and independently with the present invention scheme.

Another advantage of the present invention is its extendable configuration. With increasing numbers of columns and rows, the present invention can achieve larger format and accessibility of the individual control.

The present invention of the freeform variable focusing lens with ASIC control integrated micromirror array comprises a plurality of micromirrors wherein the micromirrors form optical surface profile and with high reflectivity reflects incident light based on each micromirror operation. Since the micromirror array device forms an optical surface profile to reflect light, it should maintain the reflectivity for the operation wavelengths. For visible application, it should maintain the reflectivity on visible wavelength and for infrared, ultraviolet and other wavelength, it should maintain the reflectivity on the specified wavelength.

The present invention of the freeform variable focusing lens with ASIC control integrated micromirror array comprises a plurality of actuators wherein the actuators make motions for the plurality of the micromirrors, wherein said each micromirror comprises at least the same number of the actuators with number of degrees of freedom for the micromirrors. To have multiple degrees of freedom motion, micromirror basically needs to have at least the same number of the actuators for each micromirror. The present invention overcomes the limitation of the individually controlled actuators through the integrity of the MEMS device and the ASIC device through TSV structures.

The present invention of the freeform variable focusing lens with ASIC control integrated micromirror array comprises a plurality of micromirror electrodes wherein the electrodes provide control voltage to the actuators to control the motion of the micromirrors. Each electrode is controlled independently.

The present invention of the freeform variable focusing lens with ASIC control integrated micromirror array comprises an ASIC device with a plurality of ASIC electrodes wherein the ASIC electrodes are fed with the control voltages generated by the ASIC device wherein the ASIC device generates the control voltages independently to control the micromirror independently and a plurality of TSVs wherein the TSVs connect the ASIC electrodes with the micromirror electrodes to provide the control voltages to the actuators to control the micromirrors.

The plurality of the micromirrors and the ASIC device are separately fabricated and wafer-bonded together at wafer level with wafer-bonding technology, said the micromirror electrodes and the ASIC electrodes are having correspondence with each other to control the micromirrors individually. The plurality of TSVs are fabricated through substrate of the plurality of the micromirror electrodes and the plurality of the ASIC electrodes.

The ASIC device controls the ASIC electrodes with column and row drivers. The column drivers generate multiple control voltages in parallel. The row drivers scan with the column drivers. The row drivers and the column drivers can have multiple sets of drivers to operate simultaneously to increase the ASIC device operation speed. The ASIC electrodes comprises capacitor to maintain the control voltage while scanning the row drivers.

While the invention has been shown and described with reference to different embodiments thereof, it will be appreciated by those skills in the art that variations in form, detail, compositions and operation may be made without departing from the spirit and scope of the invention as defined by the accompanying claims.

This work was supported by the Industrial Technology Innovation Program (20026046) funded by the Ministry of Trade, Industry & Energy (MOTIE, Korea).

What is claimed is:

1. A freeform variable focusing lens with ASIC control integrated micromirror array comprising:
a. a micromirror array device forming reflective type freeform optical surfaces with variable focusing property comprising:
i. a plurality of micromirrors wherein the micromirrors are arranged in an array and said each micromirror have at least two actuators with individually and independently controlled electrodes;
ii. a substrate for the micromirror array device wherein the said substrate has a plurality of MEMS electrodes to operate the individual actuators; and
iii. a plurality of connecting means connected through the substrate from one side of the substrate (where the micromirrors are present) to the other side of the substrate to deliver control voltages of the electrodes;
b. an ASIC (Application-Specific Integrated Circuit) device generating the control voltages of the actuators in the micromirror array device comprising:
i. a plurality of ASIC electrodes wherein the plurality of the ASIC electrodes provide control voltages to the actuators in the micromirror array device through the plurality of the connecting means in the substrate of the micromirror array device:
ii. a plurality of column drivers to generates control voltages through DACs (Digital to Analog Converter) and determine voltages for the part of the plurality of the ASIC electrode;
iii. a plurality of row drivers to times can for the optical surface data, wherein the row drivers deliver the control voltages from the column drivers to the plurality of the ASIC electrodes with timed switching method;
iv. a timing controller generating timing signals for the column drivers and the row drivers to provide the control voltages to the plurality of the ASIC electrodes;
v. high voltage amplifiers generating high voltages enough to operating the actuators in the micromirror array device;
vi. external connections providing the freeform optical surfaces in the control voltage format data and providing power supplies to the ASIC device; and
vii. a memory device for data storage of the freeform optical surfaces to operate as a variable focusing lens;
wherein the micromirror array device and the ASIC device are bonded together while fabricating and wherein the control voltages are delivered from the plurality of the ASIC electrodes to the plurality of the MEMS electrodes through the connecting means in the substrate for the plurality of the micromirrors, the ASIC electrodes and the MEMS electrodes have correspondence to control the individual micromirrors in the micromirror array device.

2. The freeform variable focusing lens with ASIC control integrated micromirror array in claim 1, wherein the substrates of the micromirror array device and the ASIC device are wafer-bonded during fabrication and diced after bonding.

3. The freeform variable focusing lens with ASIC control integrated micromirror array in claim 1, wherein the plurality of the micromirrors have multiple degrees of freedom of motion independently wherein the micromirrors have at least the same number of actuators in the individual micromirror.

4. The freeform variable focusing lens with ASIC control integrated micromirror array in claim 1, wherein the connecting means in the substrate of the micromirror array device are built with TSV (through silicon via) technology.

5. The freeform variable focusing lens with ASIC control integrated micromirror array in claim 1, wherein the connecting means have honeycomb structures to have higher density of the connecting means in the substrate of the micromirror array device.

6. The freeform variable focusing lens with ASIC control integrated micromirror array in claim 1, wherein the MEMS electrodes have one-to-one correspondence with the actuators in the micromirror array device.

7. The freeform variable focusing lens with ASIC control integrated micromirror array in claim 1, wherein the MEMS electrodes and the ASIC electrodes have one-to-one correspondence to deliver the control voltages from the ASIC device to the micromirror array device.

8. The freeform variable focusing lens with ASIC control integrated micromirror array in claim 1, wherein the actuators in the micromirror array device are actuated with electrostatic force.

9. The freeform variable focusing lens with ASIC control integrated micromirror array in claim 1, wherein the ASIC device comprises row and column as the number of the row drivers and the number of the column drivers.

10. The freeform variable focusing lens with ASIC control integrated micromirror array in claim 1, wherein the row drivers scan progressively the control voltages every row in order.

11. The freeform variable focusing lens with ASIC control integrated micromirror array in claim 1, wherein the row drivers scan interlaced to have less delay between frames.

12. The freeform variable focusing lens with ASIC control integrated micromirror array in claim 1, wherein the memory device for data storage can be placed outside of the ASIC device, wherein the outside memory device for data storage can be accessed from the ASIC device directly.

13. The freeform variable focusing lens with ASIC control integrated micromirror array in claim 1, wherein the memory device stores multiples of optical surface profile data and selected data is transferred the ASIC device and then the micromirror array device to have actual optical surfaces with the micromirrors.

14. The freeform variable focusing lens with ASIC control integrated micromirror array in claim 1, wherein the optical profiles satisfy focusing condition and phase-matching condition to form lens surfaces and said each optical surface profile corresponds to the different focal length of the optical system where the freeform variable focusing lens with ASIC control integrated micromirror array is used.

15. The freeform variable focusing lens with ASIC control integrated micromirror array in claim 1, wherein the freeform optical surfaces are changed with control thus the focal length of the freeform variable focusing lens changes wherein the optical surface control voltages are generated by the ASIC device.

16. The freeform variable focusing lens with ASIC control integrated micromirror array in claim 1, wherein the optical surface profile can have other than optical surface profiles with circular symmetry.

17. A method for operating a freeform variable focusing lens with ASIC control integrated micromirror array comprising steps of:
a. receiving command for focus changing from a main system control mean;
b. reading data from memory for an optical surface based on the command for the focus;
c. looping with row drivers for generating frame data of the optical surface profile with below column driver step;
d. generating voltages for set of column driver voltage
e. generating the optical surface profile based on the focus information from the command for the focus;
f. if new command for a new focus is received, perform step of b. reading data and;
g. if new command is not received, perform step of c. looping with row drivers to refresh the frame data;
h. separating individual chips from the bonded MEMS and ASIC wafers and exposing the electrical wire bond-pads;
wherein the looping with row drivers is continuously performed while the freeform variable focusing lens with ASIC control integrated micromirror array is operating.

18. The method for operating the freeform variable focusing lens with ASIC control integrated micromirror array in claim 17, the memory for optical surface profiles are internally integrated with ASIC device.

19. The method for operating the freeform variable focusing lens with ASIC control integrated micromirror array in claim 17, the memory for optical surface profiles are externally connected with ASIC device.

20. The method for operating the freeform variable focusing lens with ASIC control integrated micromirror array in claim 17, the row driver scans the rows progressively to cover the frame for the optical surface profile.

21. The method for operating the freeform variable focusing lens with ASIC control integrated micromirror array in claim 17, the row driver scans the rows interlaced to cover the frame for the optical surface profile, effectively twice the scanning speed.

22. The method for operating the freeform variable focusing lens with ASIC control integrated micromirror array in claim 17, the data from memory for the optical surfaces are pre-determined and stored in the memory before the operation of the freeform variable focusing lens with ASIC control integrated micromirror array.

23. A freeform variable focusing lens with ASIC control integrated micromirror array device comprising:
a. a plurality of micromirrors wherein the micromirrors form optical surface profile and with high reflectivity reflects incident light based on each micromirror motion;
b. a plurality of actuators wherein the actuators make motions for the plurality of the micromirrors, wherein said each micromirror comprises at least the same number of the actuators with number of degree of freedom for the micromirrors
c. a plurality of micromirror electrodes wherein the electrodes provide control voltage to the actuators to control the motion of the micromirrors;
d. an ASIC device with a plurality of ASIC electrodes wherein the ASIC electrodes are fed with control voltages generated by the ASIC device wherein the ASIC device generates the control voltages independently to control the micromirror independently;
e. a plurality of TSVs wherein the TSVs connect the ASIC electrodes with the micromirror electrodes to provide the control voltages to the actuators to control the micromirrors;
wherein the plurality of the micromirrors and the ASIC device are separately fabricated and wafer-bonded together at wafer level with wafer-bonding technology, said the micromirror electrodes and the ASIC electrodes are having correspondence with each other to control the micromirrors individually.

24. The freeform variable focusing lens with ASIC control integrated micromirror array device in claim 23, wherein the plurality of TSVs are fabricated through substrate of the plurality of the micromirror electrodes and the plurality of the ASCI electrodes.

25. The freeform variable focusing lens with ASIC control integrated micromirror array device in claim 23, wherein the ASIC device controls the ASIC electrodes with column and row drivers.

26. The freeform variable focusing lens with ASIC control integrated micromirror array device in claim 25, wherein the column drivers generate multiple control voltages in parallel.

27. The freeform variable focusing lens with ASIC control integrated micromirror array device in claim 25, wherein the row drivers scan with the column drivers.

28. The freeform variable focusing lens with ASIC control integrated micromirror array device in claim 25, wherein the row drivers and the column drivers can have multiple sets of drivers to operate simultaneously to increase the ASIC device operation speed.

29. The freeform variable focusing lens with ASIC control integrated micromirror array device in claim 25, wherein the ASIC electrodes comprise capacitors to maintain the control voltage while scanning the row drivers.
